(19) United States
(12) Patent Application Publication
(10) Pub. No.: US 2021/0383255 A1
(43) Pub. Date: Dec. 9, 2021

(54) ANSWER INTEGRATING DEVICE, ANSWER INTEGRATING METHOD, AND ANSWER INTEGRATING PROGRAM

(71) Applicant: NEC Corporation, Minato-ku, Tokyo (JP)

(72) Inventors: Kunihiro TAKEOKA, Tokyo (JP); Masafumi OYAMADA, Tokyo (JP)

(73) Assignee: NEC Corporation, Minato-ku, Tokyo (JP)

(21) Appl. No.: 17/288,143

(22) PCT Filed: Nov. 1, 2018
(86) PCT No.: PCT/JP2018/040638

§ 371 Date: Apr. 23, 2021

(51) Int. Cl. G06N 5/04; G06N 20/00

(52) U.S. Cl. CPC G06N 5/04; G06N 20/00

(57) ABSTRACT

An input unit 81 inputs an annotation result that is data to which a label is added based on an annotator's answer, and label addition information that indicates an inter-label structure. An answer integration unit 82 integrates the annotation results and estimates the label of the data. A skill estimation unit 83 estimates a skill of the annotator based on a difference between the estimated label and the labels included in the annotation results. An update unit 84 updates, based on the estimated skill of the annotator, the feature of a task for adding a label the inter-label structure of which is specified based on the label addition information to the data, the update being performed so that the feature conforms to the annotation results. An output unit 85 outputs the label estimated by the answer integration unit 82. The answer integration unit 82 estimates the label based on a weight calculated in accordance with closeness of the skill of the annotator and the feature of the task to the label.

### TECHNICAL FIELD

The present invention relates to an answer integrating device, an answer integrating method, and an answer integrating program for integrating answers about labels to be added to data used as training data.

### BACKGROUND ART

Due to the growing demand for data analysis, forecasting and analysis based on a large amount of data are generally performed. When making prediction and analysis, labeling (annotating) collected data enables the labeled data to be used as training data.

Although it is possible to collect large amounts of unlabeled data, labeling (or annotating) the collected data is costly. Annotation, however, needs to be done by a person (an annotator) in preparation for data analysis.

When a person performs the labeling, a certain amount of noise is likely to occur. If the labeled data contains noise, it will adversely affect learning, thereby requiring creation of high-quality training data and collection of training data that is effective for learning a model. Since the quality of training data depends in large part on the skill of the annotator, various learning methods that take into account the skill of the annotator have been proposed.

Non Patent Literature (NPL) 1 describes a method of estimating a true label in consideration of the skill of the annotator. In the method described in NPL 1, a true label is estimated by modeling the skill of the annotator and the feature of a task with a multidimensional vector and then finding the parameters that maximize the joint distribution based on the generative model related to the annotation result.

In addition, NPL 2 describes a method of incorporating external knowledge in order to acquire more specific knowledge. In the method described in NPL 2, the skill of the annotator is expressed in terms of one-dimensional reliability and answers are integrated by using an inter-label structure.

In addition, NPL 3 describes Poincare embedding, which is a method for acquiring a numerical (vector) representation corresponding to each node of the hierarchical structure.

### CITATION LIST

### Non Patent Literatures

NPL 1: Peter Welinder, Steve Branson, Serge Belongie, and Pietro Perona, “The Multidimensional Wisdom of Crowds,” Advances in Neural Information Processing

NPL 2: Tao Han, Hailong Sun, Yangqiu Song, Yili Fang, Xudong Liu, “Incorporating External Knowledge into Crowd Intelligence for More Specific Knowledge Acquisition,” IJCAI, 25th, 2016.

NPL 3: Nickel M. et al., “Poincare Embeddings for Learning Hierarchical Representations,” NIPS, 2017.

### SUMMARY OF INVENTION

### Technical Problem

The method described in NPL 1 takes into account the skill of the annotator, while not taking into account the label to be added. On the other hand, in the method described in NPL 2, the answers are integrated by using the inter-label structure, thereby enabling the accuracy of integration to be further improved. In the method described in NPL 2, however, the reliability of the annotator and the difficulty of the task are treated only by one-dimensional variables, and the skill of the annotator and the feature of the task can only be measured by the degrees of reliability and difficulty. Therefore, it cannot be said that the method described in NPL 2 is sufficiently accurate to integrate the answers to annotations.

Therefore, it is an object of the present invention to provide an answer integrating device, an answer integrating method, and an answer integrating program that enable answers about the labels to be added to data used as training data to be efficiently integrated.

### Solution to Problem

According to an aspect of the present invention, there is provided an answer integrating device including: an input unit that inputs an annotation result that is data to which a label is added based on an annotator's answer, and label addition information that indicates an inter-label structure; an answer integration unit that integrates the annotation results and estimates the label of the data; a skill estimation unit that estimates a skill of the annotator based on a difference between the estimated label and the labels included in the annotation results; an update unit that updates, based on the estimated skill of the annotator, the feature of a task for adding a label the inter-label structure of which is specified based on the label addition information to the data, the update being performed so that the feature conforms to the annotation results; and an output unit that outputs the label estimated by the answer integration unit, wherein the answer integration unit estimates the label based on a weight calculated in accordance with closeness of the skill of the annotator and the feature of the task to the label.

According to another aspect of the present invention, there is provided an answer integrating method including: inputting an annotation result that is data to which a label is added based on an annotator's answer, and label addition information that indicates an inter-label structure; integrating the annotation results and estimating the label of the data; estimating a skill of the annotator based on a difference between the estimated label and the labels included in the annotation results; updating, based on the estimated skill of the annotator, the feature of a task for adding a label the inter-label structure of which is specified based on the label addition information to the data, the update being performed so that the feature conforms to the annotation results; and outputting the estimated label, wherein, in integrating the annotation results, the label is estimated based on a weight calculated in accordance with closeness of the skill of the annotator and the feature of the task to the label.

According to still another aspect of the present invention, there is provided an answer integrating program causing a computer to perform: an input process of inputting an annotation result that is data to which a label is added based on an annotator's answer, and label addition information that indicates an inter-label structure; an answer integration process of integrating the annotation results and estimating the label of the data; a skill estimation process of estimating a skill of the annotator based on a difference between the estimated label and the labels included in the annotation results; an update process of updating, based on the estimated skill of the annotator, the feature of a task for adding a label the inter-label structure of which is specified based on the label addition information to the data, the update being performed so that the feature conforms to the annotation results; and an output process of outputting the label estimated by the answer integration process, wherein, in the answer integration process, the computer is caused to estimate the label based on a weight calculated in accordance with closeness of the skill of the annotator and the feature of the task to the label.

### Advantageous Effects of Invention

According to the present invention, even in the case where the skill of the annotator and the feature of the task are unknown in advance, answers about the labels to be added to data used as training data are able to be efficiently integrated.

### BRIEF DESCRIPTION OF DRAWINGS

FIG. 1 It depicts a block diagram illustrating a configuration example of one exemplary embodiment of an answer integrating device according to the present invention.

FIG. 2 It depicts an explanatory diagram illustrating an example of label addition information.

FIG. 3 It depicts an explanatory diagram illustrating another example of label addition information.

FIG. 4 It depicts an explanatory diagram illustrating an example of visualizing the skill of an annotator.

FIG. 5 It depicts an explanatory diagram illustrating another example of visualizing the skill of an annotator.

FIG. 6 It depicts a flowchart illustrating an operation example of the answer integrating device.

FIG. 7 depicts a block diagram illustrating an outline of the answer integrating device according to the present invention.

FIG. 8 depicts a schematic block diagram illustrating the configuration of a computer according to at least one exemplary embodiment.

### DESCRIPTION OF EMBODIMENT

Hereinafter, exemplary embodiments of the present invention will be described with reference to appended drawings.

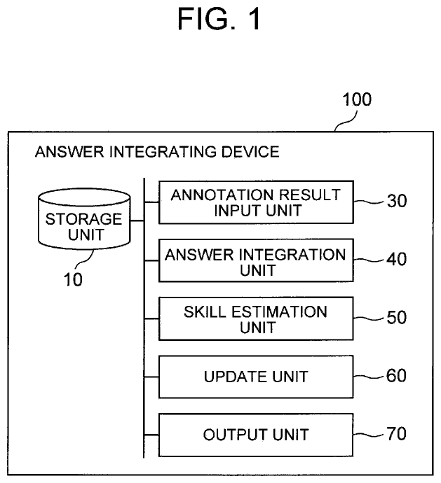

FIG. 1 is a block diagram illustrating a configuration example of one exemplary embodiment of an answer integrating device according to the present invention. The answer integrating device 100 of this exemplary embodiment includes a storage unit 10, an annotation result input unit 30, an answer integration unit 40, a skill estimation unit 50, an update unit 60, and an output unit 70.

The storage unit 10 stores additional information of a label to be added to data used as training data (hereinafter, simply referred to as “label addition information”). The label addition information in this exemplary embodiment is information indicating an inter-label structure, specifically, a text indicating the degree of relevance between labels, the closeness, the degree of similarity, a text indicating the meaning of a label, and the like.

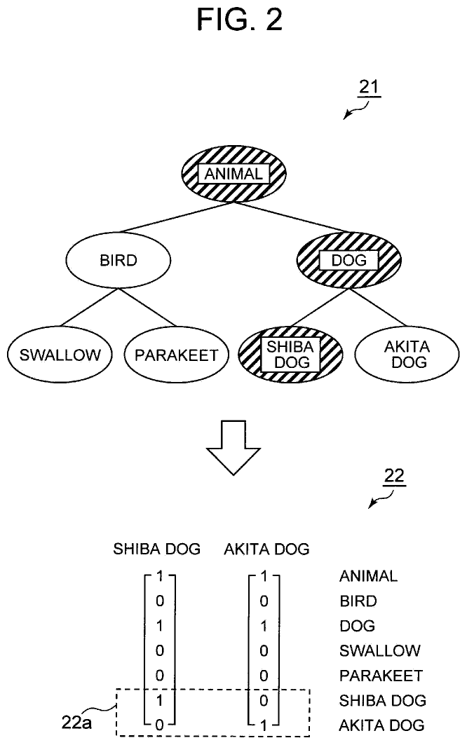

FIG. 2 is an explanatory diagram illustrating an example of label addition information. The label addition information 21 illustrated in FIG. 2 represents a hierarchical structure of labels in a tree structure, where an upper label of each node represents the label of a higher concept of a lower node. For example, the label addition information 21 illustrated in FIG. 2 means that “Shiba dog” is included in “dog,” “dog” is included in animal, and “Shiba dog” and “Akita dog” belonging to similarly “dog” have a strong tie between labels.

In addition, the label addition information 21 illustrated in FIG. 2 is able to also be represented by label addition information 22 represented by vectors. The label addition information 22 illustrated in FIG. 2 is an example of “Shiba dog” and “Akita dog” in the label addition information 21 in vector representation. Each vector illustrated in FIG. 2 is a binary vector in which 1 is set for a node through which a path passes, and the vector representations are close to each other because only the last branch part 22a is different. From this, it can be said that the vectors show a strong tie between the labels.

The method of representing the hierarchical structure is not limited to a tree structure. For example, the hierarchical structure may be represented by using the Poincare embedding technique described in NPL 3. The use of the label addition information of the hierarchical structure enables a use of the skills of the overlapping part (in the example illustrated in FIG. 2, the skill related to “Shiba dog” and the skill related to “dog”) in common.

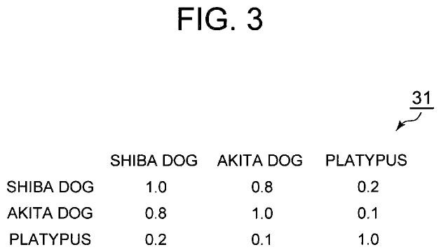

FIG. 3 is an explanatory diagram illustrating another example of label addition information. The addition information 31 illustrated in FIG. 3 indicates that the similarity between the labels is represented in a matrix format. For example, “Shiba dog” and “Akita dog” have a similarity of 0.8, indicating that they are similar, while “Shiba dog” and “platypus” have a similarity of 0.2, indicating that they are not similar. According to this label addition information, it can be assumed that an annotator who is familiar with “Shiba dog” is also familiar with “Akita dog” that has a high degree of similarity, but that it is unclear whether or not the annotator is familiar with “platypus” that has a low degree of similarity.

Note that the representations that maintain the degree of similarity (relationship) are not limited to the representations illustrated in FIG. 3. The similarity between labels may be represented in an arbitrary method such as, for example, a vector representation by dimensional compression (Spectral Embedding).

In addition, the storage unit 10 stores an annotation result obtained by each annotator, where the annotation result is data labeled by the annotator. Since the final training data integration is performed based on this annotation result, the annotation result can also be referred to as a training data candidate. In this exemplary embodiment, it is assumed that this annotation result has already been obtained.

Furthermore, the storage unit 10 stores information representing the skill of the annotator and information representing the feature of the task (hereinafter, simply referred to as the skill of the annotator and the feature of the task). The task of this exemplary embodiment is to make a query about a label to be added to certain data. Particularly, in this exemplary embodiment, the task is to add a label the inter-label structure of which is specified based on the label addition information to the data. For example, in the example illustrated in FIG. 2, the task is to make a query about “whether it is a calico cat (Yes/No)” described in “the end label of the hierarchy” for an image.

The feature of a task is an abstract concept of adding a predetermined label to certain data, and is specifically represented by a vector indicating each feature of the task. Particularly, in this exemplary embodiment, the feature of the label is represented including label addition information. In other words, when adding labels to the same type of data, the closer the label structure indicated by label addition information in the feature of the label, the closer the feature of the task. For example, in the case of label addition information illustrated in FIG. 2, it can be said that the degree of commonality of tasks is represented by vector representations.

The skill of the annotator is a concept that represents annotator's expertise in a label that the annotator adds to a task, and is specifically represented by a vector that represents the skill of the annotator adding the label. Particularly, in this exemplary embodiment, it is assumed that the skill of the annotator is closer as the label structure indicated by the label addition information is closer. For example, if the label “Shiba dog” is close to the label “dog,” it is assumed that an annotator who is familiar with “Shiba dog” is also familiar with “dog.”

In this exemplary embodiment, tasks are assigned to a plurality of annotators and answers (annotation results) are collected. Specifically, in this exemplary embodiment, there is a plurality of annotation results (training data candidates) answered by the plurality of annotators for one piece of data. Since a plurality of annotators is involved, it is assumed that the collected annotation results contain noise. Therefore, in this exemplary embodiment, the collected annotation results are integrated to determine a label to be added to each data.

It should be noted that each of the plurality of annotators has a skill (expertise), and the task also has a feature according to the label addition information. In this exemplary embodiment, however, it is assumed that the skill of the annotator (expertise) and the feature of the task is unknown in advance.

The annotation result input unit 30 inputs an annotation result and label addition information into the answer integration unit 40. In this exemplary embodiment, it is assumed that the annotation result input unit 30 acquires an annotation result stored in the storage unit 10 and then inputs the annotation result to the answer integration unit 40. The annotation result input unit 30, however, may acquire the annotation result from another storage server (not illustrated) via a communication network and then input the annotation result to the answer integration unit 40.

If the label addition information is represented by a text indicating the meaning of a label, the annotation result input unit 30 may calculate the degree of relevance between labels based on the degrees of similarity of the texts of the labels. The method of calculating the degree of similarity of texts is widely known, and therefore detailed description is omitted here.

The answer integration unit 40 integrates annotation results to estimate the label of each data. In the initial state, the answer integration unit 40 may estimate the most common label having been added as the label of each data. In this exemplary embodiment, the answer integration unit 40 estimates the label of each data according to the skill of the annotator and the feature of the task.

Specifically, the answer integration unit 40 may calculate a weight so that the higher the skill of the annotator (expertise) for each label, the greater the weight. In addition, the answer integration unit 40 may calculate a weight so that the higher the skill (expertise) of the label whose feature of a task is close, the greater the weight for the annotation result is. Then, the answer integration unit 40 may estimate the label with the largest sum of weights as the label of each data. This means that an answer of an annotator with higher expertise is preferentially applied over an answer of an annotator with lower expertise and that a skill for a task with a label that is closer in structure (closer to the feature of the task) to a target label is more taken into account. The method of estimating the skill of the annotator and the feature of the task will be described later.

The answer integration unit 40 may calculate, for example, an inner product of a feature vector representing the feature of the task and a skill vector representing the skill of the annotator and calculate a value (likelihood) indicating how well each annotator fits for each task to use the calculated likelihood as a weight. It can be said that this value is an index indicating how appropriately an annotator responds to the suitability of a label. In addition, the more the skill of the annotator and the feature of the task match, the larger the calculated inner product of the above-mentioned feature vector and skill vector will be.

The skill estimation unit 50 estimates the skill of the annotator based on an annotation result. Specifically, the skill estimation unit 50 estimates the annotation skill so that the smaller a difference between the label estimation result obtained by the answer integration unit 40 and the annotation result obtained by each annotator is, the higher the skill (expertise) is. This is because it is assumed that the more the annotation result matches the label estimation result, the more skill is required to select the label appropriately. The skill estimation unit 50 may, for example, optimize the skill of each annotator so that the difference between the likelihood and the label estimation result described above is minimized.

The update unit 60 updates the feature of the task. Specifically, the update unit 60 updates the feature of the task so that the feature confirms to the actual annotation result, based on the skill of the annotator estimated by the skill estimation unit 50. The update unit 60 may update the feature of the task for which the label addition information is taken into account, for example, by using the vector representation of the tree-structured path illustrated in FIG. 2 as a parameter of the generative model of the task. In addition, the update unit 60 may update the feature of the task for which the label addition information is taken into account, for example, by vectorizing the similarity matrix between labels illustrated in FIG. 3 and using the vectorized similarity matrix as a parameter of the generative model of the task.

In this exemplary embodiment, description has been made on a case where the skill estimation unit 50 and the update unit 60 perform estimation of the skill and update of the feature of the task, respectively. The skill estimation unit 50 and the update unit 60, however, may work together to estimate the skill and to update the feature of the task.

The answer integration unit 40 determines whether the change in the skill of the annotator estimated by the skill estimation unit 50 and the change in the feature of the task calculated by the update unit 60 have converged. Unless the changes have converged, the answer integration unit 40 reintegrates the annotation results, and the skill estimation unit 50 and the update unit 60 respectively repeat the annotator's skill estimation process and the task feature update process. The criteria for determining whether or not the changes have converged may be set in advance.

The output unit 70 outputs the label estimated by the answer integration unit 40 if it is determined that the changes have converged. The output unit 70 may display the estimated label and the corresponding data on a display (not illustrated) such as a display device and may output and store the result of associating the estimated label with the data to and in the storage unit 10.

The output unit 70 may also output the estimated skill of each annotator. In this exemplary embodiment, the skill of the annotator represents the expertise of the annotator in the label to be added to a task, and the structure of each label is specified by label addition information. Therefore, the output unit 70 may output the skill of the annotator in accordance with the structure of each label that is specified based on the label addition information.

Specifically, the output unit 70 may output the structure of each label that is specified based on the label addition information in a manner corresponding to the skill of the annotator. For example, if the label addition information is represented in a hierarchical structure of labels, the output unit 70 may highlight the label of each corresponding node in the hierarchical structure, depending on the skill of the annotator for each label. At this time, the output unit 70 may more highlight the label of the corresponding node as the skill of the annotator is higher. In other words, the output unit 70 may output a hierarchical structure of labels with the corresponding nodes highlighted according to the skill of the annotator for each label.

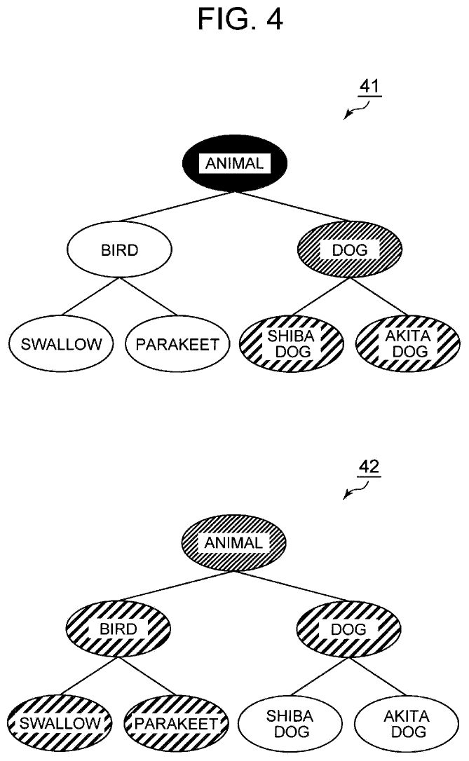

FIG. 4 is an explanatory diagram illustrating an example of visualizing the skill of the annotator. FIG. 4 illustrates an example of a graph in which the output unit 70 visualizes the skill of the annotator specified by a tree structure in the case where the label addition information is represented by the tree structure. Specifically, the graph illustrated in FIG. 4 illustrates that the darker the node color is, the higher the skill of the label (higher expertise) is, and that the lighter the node color is, the lower the skill of the label is.

The graph 41 illustrated in FIG. 4 represents that the annotator is very familiar with “dog,” though having little grasp of birds. In addition, the graph 42 illustrated in FIG. 4 represents that the annotator is familiar with birds to some extent and also knows a little about “dogs,” though not having a grasp of dog breeds.

In the example illustrated in FIG. 4, highlighting is performed to indicate the height of expertise with the color depth of the node, but the method of highlighting of the expertise is not limited to the method of changing the color mode. The output unit 70, for example, may highlight the label of each node by changing the size of an area, the thickness of an outer line, the brightness, the luminance, or the like or by associating the quantified skill with the label.

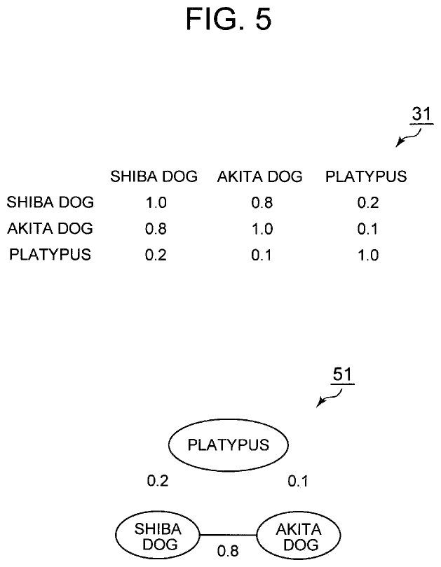

FIG. 5 is an explanatory diagram illustrating another example of visualizing the skill of the annotator. FIG. 5 illustrates an example of a graph in which the output unit 70 visualizes the skill of the annotator according to the degree of similarity, where the label addition information is in the form of a matrix representing the degree of similarity between labels. A graph 51 illustrated in FIG. 5 is a graph in which the nodes representing the respective labels are connected by edges in the case where the degree of similarity between the labels is equal to or greater than a predetermined threshold (for example, 0.5).

In this manner, the output unit 70 outputs the skill of the annotator in accordance with the structure of each label that is specified based on the label addition information, thereby enabling the skill of the annotator to be explicitly understood.

The annotation result input unit 30, the answer integration unit 40, the skill estimation unit 50, the update unit 60, and the output unit 70 are implemented by computer processors (for example, a central processing unit [CPU], a graphics processing unit [GPU], and a field-programmable gate array [FPGA]) that operate according to a program (answer integrating program).

For example, the program is stored in the storage unit 10 of the answer integrating device, and the processors may read the program to operate as the annotation result input unit 30, the answer integration unit 40, the skill estimation unit 50, the update unit 60, and the output unit 70 according to the program. In addition, the function of the answer integrating device may be provided in a software-as-a-service (SaaS) format.

The annotation result input unit 30, the answer integration unit 40, the skill estimation unit 50, the update unit 60, and the output unit 70 may each be implemented by dedicated hardware. In addition, some or all of the components of each device may be implemented by general-purpose or dedicated circuitry, a processor, or the like or by a combination thereof. These may be composed of a single chip or multiple chips connected via a bus. Some or all of the components of each device may be implemented by a combination of the above-mentioned circuitry or the like and a program.

Further, in the case where some or all of the components of the answer integrating device are implemented by a plurality of information processing devices, circuitry, and the like, the plurality of information processing devices and circuitry may be centrally arranged or distributed. For example, the information processing devices, the circuitry, and the like may be implemented in a form in which a client-server system, a cloud computing system, and the like are connected via a communication network.

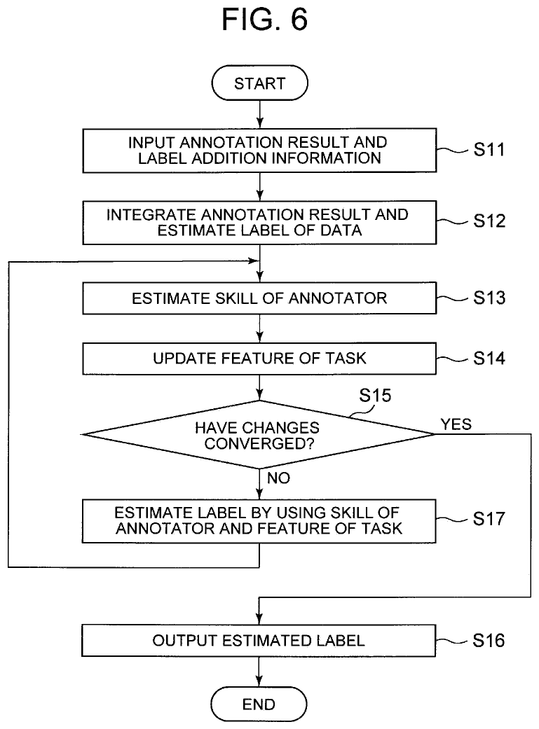

Subsequently, the operation of the answer integrating device of this exemplary embodiment will be described. FIG. 6 is a flowchart illustrating an operation example of the answer integrating device 100 of this exemplary embodiment. The annotation result input unit 30 inputs annotation results and label addition information into the answer integration unit 40 (step S11). The answer integration unit 40 integrates the annotation results and estimates a label of the data (step S12). In the initial state, the skill of the annotator used to integrate the annotation results is not estimated, and therefore the answer integration unit 40 may estimate the label of the data, for example, by majority voting of the selected labels.

The skill estimation unit 50 estimates the skill of the annotator based on the difference between the estimated label and the labels included in the annotation results (step S13). The update unit 60 updates, based on the estimated skill of the annotator, the feature of a task so that the feature conforms to the annotation results (step S14), where the feature of the task to be updated is a feature that represents a task for adding a label the inter-label structure of which is specified based on the label addition information.

The answer integration unit 40 determines whether the change in the skill of the annotator and the change in the feature of the task have converged (step S15). If the changes have converged (Yes in step S15), the output unit 70 outputs the label estimated by the answer integration unit 40 (step S16). Note that the output unit 70 may output the estimated skill of the annotator in addition to the estimated label.

On the other hand, unless the changes have converged (No in step S15), the answer integration unit 16 integrates the annotation results based on a weight calculated in accordance with the closeness of the skill of the annotator and the feature of the task to the label to estimate the label of data (step S17). Thereafter, the processing after step S13 is repeated.

As described above, in this exemplary embodiment, the annotation result input unit 30 inputs annotation results and label addition information, and the answer integration unit 40 integrates the annotation results to estimate the label of the data, and the output unit 70 outputs the estimated label. At this point, the skill estimation unit 50 estimates the skill of the annotator based on a difference between the estimated label and the labels included in the annotation results, and the update unit 60 updates, based on the estimated skill of the annotator, the feature of the task so that the feature conforms to the annotation results. The answer integration unit 40 then estimates the label of the data by integrating the annotation results based on a weight calculated in accordance with the closeness of the skill of the annotator and the feature of the task to the label.

In this manner, the label addition information is able to be reflected on the skill of the annotator and on the feature of the task, thereby enabling the label addition information to be used for efficient answer integration (quality control). In other words, the answers about the labels to be added to data used as training data are able to be efficiently integrated.

For example, the method described in NPL 1 did not have the idea of using label addition information, which indicates the structure of the labels themselves. Furthermore, although the use of knowledge labels represented by a hierarchical tree structure has been described in the method described in NPL 2, the description does not include a technical idea that the skill of the annotator itself is associated with a label structure. On the other hand, in this exemplary embodiment, the label addition information is able to be used for efficient learning of the skill of the annotator and the feature of the task, which enables highly accurate answer integration.

Furthermore, in general, the skill of the annotator has been a potential feature, but in this exemplary embodiment, the output unit 70 outputs the skill of the annotator in accordance with the structure of each label that is specified based on the label addition information. Therefore, the dependency of the skill (expertise) of the annotator on the label addition information is able to be easily presented.

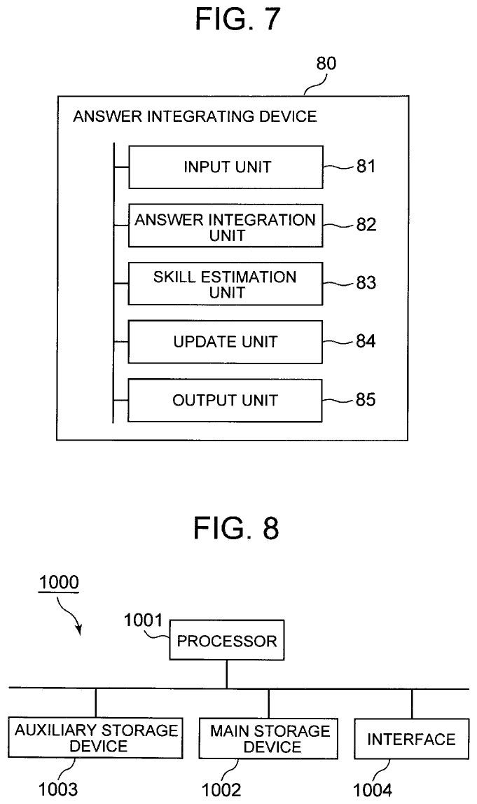

Subsequently, the outline of the present invention will be described. FIG. 7 is a block diagram illustrating an outline of the answer integrating device according to the present invention. An answer integrating device 80 (for example, the answer integrating device 100) according to the present invention includes an input unit 81 (for example, the annotation result input unit 30) that inputs an annotation result that is data to which a label is added based on an annotator's answer, and label addition information that indicates an inter-label structure; an answer integration unit 82 (for example, the answer integration unit 40) that integrates the annotation results and estimates the label of the data; a skill estimation unit 83 (for example, the skill estimation unit 50) that estimates a skill of the annotator based on a difference between the estimated label and the labels included in the annotation results; an update unit 84 (for example, the update unit 60) that updates, based on the estimated skill of the annotator, the feature of a task for adding a label the inter-label structure of which is specified based on the label addition information to the data, the update being performed so that the feature conforms to the annotation results; and an output unit 85 that outputs the label estimated by the answer integration unit 82.

The answer integration unit 82 estimates the label based on a weight calculated in accordance with closeness of the skill of the annotator and the feature of the task to the label.

The above configuration enables efficient integration of the answers about the label to be added to the data used as training data, even in the case where the skill of the annotator or the feature of the task is unknown in advance.

In addition, the output unit 85 may output the structure of each label that is specified based on the label addition information in a manner corresponding to the skill of the annotator. This configuration enables understanding of the dependency of the skill (expertise) of the annotator on the label addition information.

Specifically, in the case where the label addition information is represented in a hierarchical structure of labels, the output unit 85 may output the hierarchical structure with the corresponding nodes highlighted according to the skill of the annotator for each label.

The output unit 85, for example, may highlight the label of the corresponding node more intensely as the skill of the annotator is higher.

Furthermore, the answer integration unit 82 may calculate the weight on the annotation result according to the skill of the annotator and the feature of the task and may estimate the label with the largest sum of weights, as the label of the data.

Furthermore, the answer integration unit 82 may calculate the weight calculated by the inner product of the feature vector and the skill vector as a weight for the annotation result.

The answer integration unit 82 may also reintegrate the annotation results to estimate the label of the data unless the change in the skill of the annotator and the change in the feature of the task have converged. This configuration enables improvement of the accuracy of labels that should be added.

FIG. 8 is a schematic block diagram illustrating the configuration of a computer according to at least one exemplary embodiment. A computer 1000 includes a processor 1001, a main memory 1002, an auxiliary storage device 1003, and an interface 1004.

The answer integrating device described above is implemented on the computer 1000. The operation of each processing unit described above is stored in the auxiliary storage device 1003 in the form of a program (an answer integrating program). The processor 1001 reads the program from the auxiliary storage device 1003, expands it to the main storage device 1002, and executes the above processing according to the program.

In at least one exemplary embodiment, the auxiliary storage device 1003 is an example of a non-temporary tangible medium. Other examples of non-temporary tangible media include a magnetic disk, a magneto-optical disk, a CD-ROM (compact disc read-only memory), a DVD-ROM (read-only memory), and a semiconductor memory, and the like, which are connected via an interface 1004. In addition, in the case where this program is distributed to the computer 1000 via a communication line, the computer 1000 that has received the distribution may expand the program to the main storage device 1002 to execute the above processing.

In addition, the program may be intended to implement some of the above-mentioned functions. Furthermore, the program may be a so-called difference file (difference program) that implements the above functions in combination with other programs already stored in the auxiliary storage device 1003.

Some or all of the above exemplary embodiments may also be described in Supplementary notes described below, but not limited thereto.

(Supplementary note 1) An answer integrating device including: an input unit that inputs an annotation result that is data to which a label is added based on an annotator's answer, and label addition information that indicates an inter-label structure; an answer integration unit that integrates the annotation results and estimates the label of the data; a skill estimation unit that estimates a skill of the annotator based on a difference between the estimated label and the labels included in the annotation results; an update unit that updates, based on the estimated skill of the annotator, the feature of a task for adding a label the inter-label structure of which is specified based on the label addition information to the data, the update being performed so that the feature conforms to the annotation results; and an output unit that outputs the label estimated by the answer integration unit, wherein the answer integration unit estimates the label based on a weight calculated in accordance with closeness of the skill of the annotator and the feature of the task to the label.

(Supplementary note 2) The answer integrating device according to Supplementary note 1, wherein the output unit outputs the structure of each label that is specified based on the label addition information in accordance with the skill of the annotator.

(Supplementary note 3) The answer integrating device according to Supplementary note 1 or 2, wherein, in the case where the label addition information is represented in a hierarchical structure of labels, the output unit outputs the hierarchical structure with the corresponding nodes highlighted according to the skill of the annotator for each label.

(Supplementary note 4) The answer integrating device according to Supplementary note 3, wherein the output unit highlights the label of the corresponding node as the annotator's skill increases.

(Supplementary note 5) The answer integrating device according to any one of Supplementary notes 1 to 4, wherein the answer integration unit calculates the weight for the annotation result in accordance with the skill of the annotator and the feature of the task, and estimates the label with the largest sum of weights as the label of the data.

(Supplementary note 6) The answer integrating device according to any one of Supplementary notes 1 to 5, wherein the answer integration unit calculates the weight calculated by an inner product of a feature vector and a skill vector as a weight for the annotation result.

(Supplementary note 7) The answer integrating device according to any one of Supplementary notes 1 to 6, wherein the answer integration unit reintegrates the annotation results to estimate the label of the data unless the change in the skill of the annotator and the change in the feature of the task have converged.

(Supplementary note 8) An answer integrating method including the steps of: inputting an annotation result that is data to which a label is added based on an annotator's answer, and label addition information that indicates an inter-label structure; integrating the annotation results and estimating the label of the data; estimating a skill of the annotator based on a difference between the estimated label and the labels included in the annotation results; updating, based on the estimated skill of the annotator, the feature of a task for adding a label the inter-label structure of which is specified based on the label addition information to the data, the update being performed so that the feature conforms to the annotation results; and outputting the estimated label, wherein, in integrating the annotation results, the label is estimated based on a weight calculated in accordance with closeness of the skill of the annotator and the feature of the task to the label.

(Supplementary note 9) The answer integrating method according to Supplementary note 8, wherein the skill of the annotator is output according to the structure of each label that is specified based on the label addition information.

(Supplementary note 10) An answer integrating program causing a computer to perform: an input process of inputting an annotation result that is data to which a label is added based on an annotator's answer, and label addition information that indicates an inter-label structure; an answer integration process of integrating the annotation results and estimating the label of the data; a skill estimation process of estimating a skill of the annotator based on a difference between the estimated label and the labels included in the annotation results; an update process of updating, based on the estimated skill of the annotator, the feature of a task for adding a label the inter-label structure of which is specified based on the label addition information to the data, the update being performed so that the feature conforms to the annotation results; and an output process of outputting the label estimated by the answer integration process, wherein, in the answer integration process, the computer is caused to estimate the label based on a weight calculated in accordance with closeness of the skill of the annotator and the feature of the task to the label.

(Supplementary note 11) The answer integrating program according to Supplementary note 10, wherein, in the output process, the computer is cause to output the skill of the annotator in accordance with the structure of each label that is specified based on the label addition information.

### REFERENCE SIGNS LIST

10 Storage unit

30 Annotation result input unit

40 Answer integration unit

50 Skill estimation unit

60 Update unit

70 Output unit

100 Answer integrating device

What is claimed is:

1. An answer integrating device comprising a hardware processor configured to execute a software code to:
input an annotation result that is data to which a label is added based on an annotator's answer, and label addition information that indicates an inter-label structure;
integrate the annotation results and estimate the label of the data;
estimate a skill of the annotator based on a difference between the estimated label and the labels included in the annotation results;
update, based on the estimated skill of the annotator, the feature of a task for adding a label the inter-label structure of which is specified based on the label addition information to the data, the update being performed so that the feature conforms to the annotation results;
output the estimated label; and
estimate the label based on a weight calculated in accordance with closeness of the skill of the annotator and the feature of the task to the label.

2. The answer integrating device according to claim 1, wherein the hardware processor is configured to execute a software code to output the structure of each label that is specified based on the label addition information in accordance with the skill of the annotator.

3. The answer integrating device according to claim 1, wherein, in the case where the label addition information is represented in a hierarchical structure of labels, the hardware processor is configured to execute a software code to output the hierarchical structure with the corresponding nodes highlighted according to the skill of the annotator for each label.

4. The answer integrating device according to claim 3, wherein the hardware processor is configured to execute a software code to highlight the label of the corresponding node as the annotator's skill increases.

5. The answer integrating device according to claim 1, wherein the hardware processor is configured to execute a software code to calculate the weight for the annotation result in accordance with the skill of the annotator and the feature of the task, and estimate the label with the largest sum of weights as the label of the data.

6. The answer integrating device according to claim 1, wherein the hardware processor is configured to execute a software code to calculate the weight calculated by an inner product of a feature vector and a skill vector as a weight for the annotation result.

7. The answer integrating device according to claim 1, wherein the hardware processor is configured to execute a software code to reintegrate the annotation results to estimate the label of the data unless the change in the skill of the annotator and the change in the feature of the task have converged.

8. An answer integrating method comprising:
inputting an annotation result that is data to which a label is added based on an annotator's answer, and label addition information that indicates an inter-label structure;
integrating the annotation results and estimating the label of the data;
estimating a skill of the annotator based on a difference between the estimated label and the labels included in the annotation results;
updating, based on the estimated skill of the annotator, the feature of a task for adding a label the inter-label structure of which is specified based on the label addition information to the data, the update being performed so that the feature conforms to the annotation results; and
outputting the estimated label,
wherein, in integrating the annotation results, the label is estimated based on a weight calculated in accordance with closeness of the skill of the annotator and the feature of the task to the label.

9. The answer integrating method according to claim 8, wherein the skill of the annotator is output in accordance with the structure of each label that is specified based on the label addition information.

10. A non-transitory computer readable information recording medium storing an answer integrating program, when executed by a processor, that performs a method for:
inputting an annotation result that is data to which a label is added based on an annotator's answer, and label addition information that indicates an inter-label structure;
integrating the annotation results and estimating the label of the data;
estimating a skill of the annotator based on a difference between the estimated label and the labels included in the annotation results;
updating, based on the estimated skill of the annotator, the feature of a task for adding a label the inter-label structure of which is specified based on the label addition information to the data, the update being performed so that the feature conforms to the annotation results; and
outputting the label estimated by the answer integration process,
wherein, the label is estimated based on a weight calculated in accordance with closeness of the skill of the annotator and the feature of the task to the label.

11. The non-transitory computer readable information recording medium according to claim 10, wherein, the skill of the annotator is output in accordance with the structure of each label that is specified based on the label addition information.
